(19) United States
(12) Patent Application Publication
(10) Pub. No.: US 2009/0233260 A1
(43) Pub. Date: Sep. 17, 2009

(54) GAME FOR EXPOSING EMPLOYEES TO THE RISKS AND DECISIONS ASSOCIATED WITH THE OPERATION OF A BUSINESS AND METHODS REGARDING THE SAME

(76) Inventor: Greg McAfee, Bellbrook, OH (US)

Correspondence Address: DINSMORE & SHOHL LLP, ONE DAYTON CENTRE, ONE SOUTH MAIN STREET, SUITE 1300, DAYTON, OH, 45402-2023, US

(21) Appl. No.: 12/402,328

(22) Filed: Mar. 11, 2009

Related U.S. Application Data
(60) Provisional application No. 61/035,644, filed on Mar. 11, 2008.

(51) Int. Cl. G09B 19/22; G09B 19/00

(52) U.S. Cl. 434/128; 434/219

(57) ABSTRACT

An apparatus and method for a game and method for teaching persons about business. A game, method, and method of play for teaching employees how to operate a business, including various issues, decisions, and/or risks one faces when operating a business.

### CROSS REFERENCE TO RELATED APPLICATIONS

This application claims the benefit of U.S. Provisional Application Ser. No. 61/035,644 filed Mar. 11, 2008 (MCF 0008 MA).

### FIELD OF THE INVENTION

The present invention generally relates to a game and method for teaching persons about business. More particularly, the present invention relates to a game, method, and method of play for exposing employees to the risks and decisions associated with the operation of a business. Even more particularly, the present invention relates to a game, method, and method of play for teaching employees how to operate a business, including various issues, decisions, and/or risks one faces when operating a business.

### BACKGROUND OF THE INVENTION

Typically, many employees have not been exposed to all the issues, decisions, and risks involved in operating a business. Thus, when decisions are made by the owners and/or managers, many employees do not appreciate all that is involved in operating a business, and more particularly the risks involved with each decision made.

### BRIEF DESCRIPTION OF THE FIGURES

The following detailed description of exemplary embodiments of the present invention can be best understood when read in conjunction with the following drawings, where like structure is indicated with like reference numerals and in which:

FIG. 1 is a top plan view of an exemplary embodiment of a playing board for a game according to the present invention; and

FIG. 2 is an exemplary embodiment of a Profit & Loss Cash Balance Sheet according to the present invention.

### DETAILED DESCRIPTION OF THE INVENTION

The following text sets forth a broad description of numerous different embodiments of the present invention. The description is to be construed as exemplary only and does not describe every possible embodiment since describing every possible embodiment would be impractical, if not impossible, and it will be understood that any feature, characteristic, component, product, step or methodology described herein can be deleted, combined with or substituted for, in whole or part, any other feature, characteristic, component, product, step or methodology described herein. Numerous alternative embodiments could be implemented, using either current technology or technology developed after the filing date of this patent, which would still fall within the scope of the claims. All publications and patents cited herein are incorporated herein by reference.

The present invention comprises a game and method designed to educate persons how to operate a business. More particularly, the game, method, and method of play may be designed to expose employees to issues such as varying risks and decisions associated with the operation of a business. Even more particularly, the game, method, and method of play may be designed to educate employees of a business on how to operate a business, including some of the issues, decisions, and risks involved in operating a business. Such a game and method assists in enlightening and/or informing employees to the many issues, decisions, and risks that a owner/manager may face and/or overcome. Such a game and method can be customized by changing the risks described on “Risks” and the cause and effects described on “Cause and Effect” cards described below herein.

The game and method may be played with any number of individuals or teams. In one exemplary embodiment, the game and method may comprise 4 to 6 players per team, with multiple teams playing at a time. For illustration purposes only, and not limitation, the exemplary embodiments set forth herein will be described with reference to teams. However, it is understood that individual players may be substituted for the term “team” throughout the present invention.

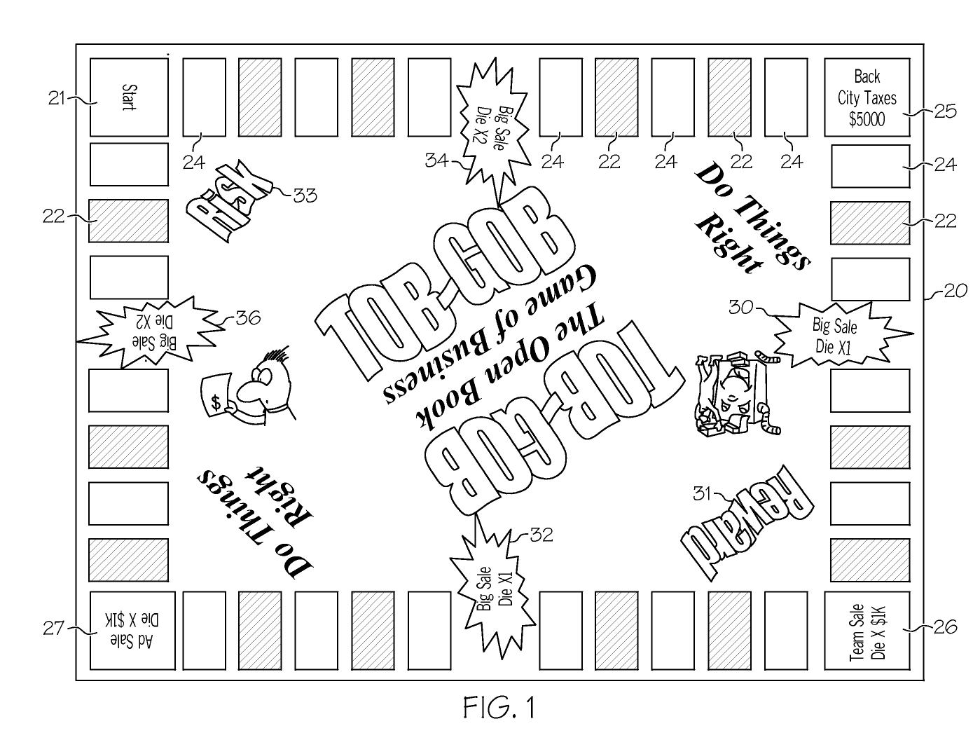

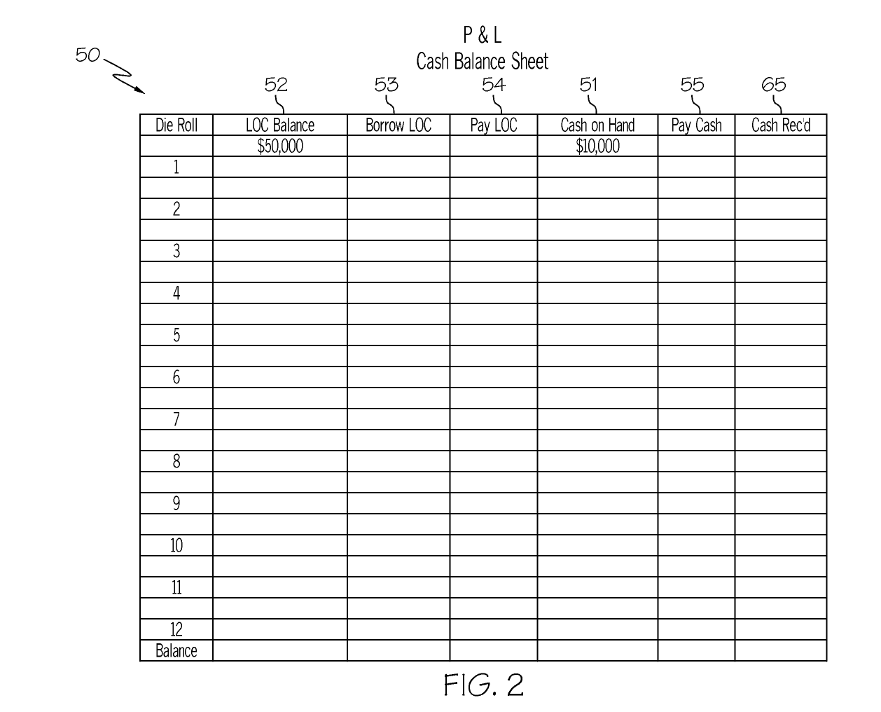

Referring to FIGS. 1 and 2, the game and method of the exemplary embodiment may comprise a board 20, a chance indicator (not shown), “Risk” cards, “Cause and Effect” cards, a profit and loss (“P&L”) sheet 50 (or Cash Balance Sheet), and a token for each team (or individual player) to move around the board during play. The “Risk” and the “Cause and Effect” cards may comprise any color and/or design as desired. The “Risk” cards' color may correspond to and/or be the same as a color of a first plurality of squares 22 disposed on the board 20. The “Cause and Effect” cards' color may correspond to or be the same as a color of a second plurality of squares 24 disposed on the board. In one exemplary embodiment, the “Risk” cards are red in color and the “Cause and Effect” cards are blue in color.

The chance indicator may comprise a body and a plurality of numbers disposed thereon such that a user may operate the chance indicator such that one of the plurality of numbers is indicated by chance. Exemplary chances indicators may include dice and a spinner having a body, an indicator rotatably mounted to the body, and a plurality of numbers disposed on the body and about the indicator as conventionally known.

In this exemplary embodiment, each team may begin with $10,000 cash on their P&L sheet as shown in a column 51, titled, “Cash on Hand”, of P&L sheet 50 of FIG. 2. This column allows each team to track the amount of cash the team has on hand. Also, each team may begin the game with up to a $50,000 line of credit to start the game as shown in a column 52, titled, “LOC Balance”, of P&L sheet 50 of FIG. 2. This permits each team to track what the current balance of the team's line of credit is. It is understood that these amounts are exemplary amounts shown for illustration purposes only, and that any amount may be used in order to play the game.

As further shown in FIG. 2, the P&L sheet 50 also may include a column 53, titled, “Borrow LOC”, for tracking how much money a team has borrowed from the “LOC Balance” 52. A column 54, titled, “Pay LOC”, permits each team to track the amount of money the team has paid back toward the moneys borrowed from the line of credit (“Borrow LOC” 53). The P&L sheet 50 may also include a “Pay Cash” column 55 and a Cash Received (“Rec'd”) column 56, wherein the “Pay Cash” column 55 permits each team to track the amount of cash the team has paid for different items, services, etc., and the “Cash Rec'd” column 56 permits each team to track the amount of cash the team has received from other entities, persons, etc., for services, goods, and other items. Each team may form a company name, designate a leader and a bookkeeper, and use a P&L sheet 50 to account their team's and/or company's financial transactions and/or performance.

As shown in FIG. 1, the board 20 may comprise a start square 21 positioned on a first corner of the board 20, the first plurality of squares 22 having a first indicia (e.g., a first color or other type of indicia) and a second plurality of squares 24 having a second indicia (e.g., a second color or other type of indicia to distinguish the second indicia from the first indicia) alternatively positioned around the board 20, an expense square 25 (e.g, “Back City Taxes $5,000” 25) positioned in a second corner of the board 20, and one or more Sale squares positioned on the remaining corners (e.g., labeled “Team Sale Die×$1K” square 26 positioned in a third corner of the board 20, and an “Ad Sale Die×$1K” square 27 positioned in a fourth corner of the board 20). If the team lands on one of the Sale squares, they roll the dice again, multiply the number they roll by $1,000 (i.e., Die×$1K), and then add that amount to their P&L sheet 50 as additional revenue. For example, if the team lands on the Team Sale square 26, they roll the dice and get a 6, then they would credit their P&L sheet 50 with $6,000 of additional revenues (6 (Die)×$1,000 ($1K)). Although the term ‘square’ is used, this term is not mean to limit the invention to the use of squares as positions on the game board 20. As such, it is understood that any number of shapes, configurations, and designs may be used to indicate the different spaces on the game board 20.

Also, it is understood that the expense square may comprise any type of expense that a business may encounter or incur during the operation of its business. Exemplary expenses may include, but not be limited to, employee salaries, raises, taxes (e.g., corporate taxes, Federal taxes, payroll taxes, city taxes, sales taxes, back taxes, etc.), vehicle purchase, lease, operation, and maintenance costs, facility maintenance and operation costs, and any other costs and/or expenses incurred in operating a business.

As set forth above in one exemplary embodiment, the “Risk” cards and their corresponding first plurality of squares 22 are red in color so as to link and queue the players that when landing on one of the red, first plurality of squares 22, the team must pick from one of the red “Risk” cards, and the “Cause and Effect” cards and their corresponding second plurality of squares 24 are blue in color so as to link and queue the players that when landing on one of the blue second plurality of squares 24, the team must pick from one of the blue “Cause and Effect” cards. It is understood that the board 20 may include one or more of and/or combination of colors for the cards and/or the first and second plurality of squares 22 and 24.

Also, it is understood that the board 20 may include one or more of and/or combination of the “Back City Taxes” square 25, “Team Sale Die×$1K” square 26, and/or “Ad Sale Die×$1K” 27, and that these squares may be disposed in other positions on the board as well. Additionally, the board 20 may comprise one or more “Big Burst” Sale squares. For example, board 20 in the exemplary embodiment shown in FIG. 1 includes a first “Big Burst” square, “Big Sale Die×1” square 30, a second “Big Burst” square, “Big Sale Die×1” square 32, a third “Big Burst” square, “Big Sale Die×2” square 34, and a fourth “Big Burst” square, “Big Sale Die×2” square 36. It is understood that the board 20 may include any number and/or combination of the “Big Burst” squares, including any number and/or combination of the “Big Sale Die×1” and “Big Sale Die×2” squares. In another exemplary embodiment, the board 20 may include two marked positions: a first position 31 for the “Cause and Effect” cards; and a second position 33 for the “Risk” cards. It is understood that the game and/or board 20 may comprise a variety of combinations of the “Big Burst” squares and a variety of positions for the “Cause and Effect” and “Risk” cards.

In the exemplary embodiment, each team places their token on the start square 21. A first team rolls the dice and then moves their token the appropriate number of squares that corresponds to the number rolled on the dice. The team will perform different tasks depending upon what type of square they land on based upon their roll of the dice. Once the first team finishes performing their task, the next team rolls the dice and moves their token the appropriate number of squares that corresponds to the number rolled on the dice. As such, each participating team follows suit until it is the first teams turn again, wherein the process starts over again. In this embodiment, the team moves their token around the board 20 in a clockwise direction, but it is understood that the game could be played in a counter-clockwise direction.

If the roll of the dice lands the team on one of the first plurality of squares 22 (e.g., a blue square), a team representative draws a “Cause and Effect” card. The “Cause and Effect” cards may comprise instructions such as, for example, the company (team) has either sold a job, which they may add this revenue from the sale to there P&L sheet 50, or incurred an expense, which they may deduct this expense from their P&L sheet 50. If the roll of the dice lands the team on one of the second plurality of squares 24, the team or team representative draws a “Risk” card. The “Risk” cards provide the company (team) a fact scenario that requires the team to make a decision according to what the card suggests. As suggested by the title of these cards, the decision has risks involved.

Exemplary cause and effect cards may include, but not be limited to the following:

### Exemplary Exemplary Card 1

An old truck has very high mileage, looks bad, and may need major overhaul soon. A new truck would require $4000 down. Yes or No?
Yes: Pay $4,000
No: Roll dice:
   1. Old truck transmission goes out, pay $2000.
   2. Old truck continues another six months, no problem.
   3. Old truck looks bad, potential client lost.
   4. Old truck blows an engine, pay $4000.
   5. Old truck requires 4 new tires, pay $1000.
   6. Old truck requires complete brake job, radiator and heater replacement, and all new hoses, pay $1500.

### Exemplary Card 2

Your computers are old, slow, and cannot be upgraded. They are causing a loss of about 4 hours a day in productivity. The new systems will cost $12,000.
   Yes or No?
Yes: Pay $12,000, roll dice:
Even—Computers pay for themselves in six months, break even, add $12,000.
Odd—No change, but productivity is increased.
No: Pay $3,000 for lack of productivity and learn to invest in your company!

### Exemplary Card 3

Sponsor a Little League Team. $1000. Yes or No?
Yes: Pay $1,000, roll dice:
1 or 6: Parents buy a new HVAC unit at $6000, add $6,000.
2-5: Nothing comes as a result of your sponsorship, but you feel good about helping your community.
   No: Roll dice:
   Even—Parent on team quits using your company, pay $500.
   Odd—Nothing happens but your choice does not help reputation.

### Exemplary Card 4

Advertise in local newspaper. $2000. Yes or No?
Yes: Pay $2,000, roll dice:
   1. No phone calls result.
   2. Ten phone calls from solicitors to sell you things. [symbol]
   3. Three estimates but no sales yet.
   4. Sell 50 service contracts, add $10,000! [symbol]
   5. Sell one commercial contract, add $5000.
   6. Your friends see the ad and congratulate you!
No: Quit saying “NO”, pay $500!

### Exemplary Card 5

Your office manager asks for a $2000 pay raise. She is very good and not overpaid by industry or community standards. Yes or No?
Yes: Pay $2,000
No: Roll dice:
   1. She leaves your company and it costs $6000 to find and train a replacement. [symbol]
   2. She stays but her output goes down by 10%. [symbol]
   3. She loves your company and stays on at no increase. [symbol] ? [symbol]
   4. She stays and performs less work. Others begin to complain about her attitude, pay $1000. [symbol]
   5. She goes to work for a competitor and takes her knowledge with her, pay $2000. [symbol]
   6. Nothing happens.

### Exemplary Card 6

Opportunity to add combustion analyzers in service trucks. $16,000. Yes or No?
Yes: Pay $16,000, roll dice:
   1. Increase of sales, $75,000 net $15,000
   2. Next round collect $5,000
   3. Tech quits, doesn't like change, pay $2,000
   4, 5, or 6. Service increase $200,000 add $20,000.
No: Lose potential sales, pay $5,000 and get with the times!

### Exemplary Card 7

Supply shoe protectors for all field employees. $500. Yes or No?
Yes: Pay $500, roll dice:
Odd—Happy customers, no change.
Even—Add $2000 from a sale due to wearing them! [symbol]
No: Pay $250 for tracking mud in a new customer's home.

[symbol]

### Exemplary Card 8

Update logo and business Exemplary Cards. $2000. Yes or No?
Yes: Pay $2,000, roll dice:
Even—No change.
Odd—Add $5,000 from getting better exposure! [symbol]
No: Pay $500 to have existing Exemplary Cards reprinted and learn to change for the better!

### Exemplary Card 9

Repave parking lot. $20,000. Yes or No?
Yes: Pay $20,000, roll dice:
Even—Win a Beautification Award! Add 10,000!! [symbol]
Odd—Safety issue resolved, but no change.
No: Roll dice:
Even—Looks bad and causes potential safety problems.
Odd—Customer falls and sues, pay $5,000!

[symbol]

### Exemplary Card 10

Order Digital Credit Exemplary Card machines. $10,000. Yes or No?
Yes: Pay $10,000, roll dice:
   1. Save $10,000 1^{st} year from less bank fees, add $10,000!
   2. Make $20,000 from impressive referrals, add $20,000! [symbol]
   3. Nothing changes.
   4, 5, or 6. Add $5000 for being business savvy!
No: Lose $5,000 for not being business savvy!

[symbol]

It should be understood that a variety of risks scenarios may be included on the risk cards and can be customized for a specific industry, business, company division, or any other desired risk scenario desired to be provided to the players and/or employees.

Exemplary cause and effect cards may include, but not be limited to the following:

### Exemplary Card 1

Cause: Health care insurance goes up $2500.
Effect: Pay bill of $2500

### Exemplary Card 2

Cause: Supplier sends wrong furnace. You have to go back and exchange.
Effect: Pay $250 for the loss, and oh yeah, supplier apologizes.

### Exemplary Card 3

Cause: Dispatcher sends you to the wrong address.
Effect: $250 loss . . . Pay $250

### Exemplary Card 4

Cause: Service tech backs truck over customer's son's new bicycle and you buy a new and better bike.
Effect: Pay $500 and roll dice.
1 or 2—Customer tells neighbor, new HVAC unit sold, add $5,000
3, 4, 5 or 6—No change

### Exemplary Card 5

Cause: Service tech did not wear shoe protectors and tracked mud on carpet. Must have carpet cleaned.
Effect: $250 loss . . . Pay $250

### Exemplary Card 6

Cause: Unhappy customer. Tech missed the driveway and drove into the yard, ruining customers landscaping.
Effect: Pay $1,000 to resolve problem.

### Exemplary Card 7

Cause: Administration was recorded spending 5 hours per week on personal websites and email.
Effect: Pay $1,000 for 3 months lost work.

### Exemplary Card 8

Cause: Tech yells at customer and she reports your company to the Better Business Bureau.
Effect: Pay $1,500 and take a customer service class.

### Exemplary Card 9

Cause: New Administrative Assistant spends an average of 1 hour per day talking with customers on phone about non-business items. AKA: rambling on.
Effect: Pay $500

### Exemplary Card 10

Cause: Tech wired circuit board wrong and causes fire at thermostat.
Effect: Pay $1,500 and send him to a low voltage wiring refresher course.

It should be understood that a variety of cause and effect scenarios may be included on the risk cards and can be customized for a specific industry, business, company division, or any other desired cause and effect scenario desired to be provided to the players and/or employees.

If the roll of the dice lands the team on one of the “Big Sale Burst” squares (e.g., squares 30, 32, 34, and 36), the team rolls the dice and then either multiplies the number that was rolled on the dice by 1 or 2 (×1 or ×2), respectively, depending on which “Big Sale Burst” square the team landed on. This product of the rolled dice number multiplied by either 1 or 2 is an added sale, which is added to the P&L sheet 50 by the team book keeper. For example, if the team moves and lands on the “Big Sale Die ×2” square 34, then the team rolls the dice a second time. If the team rolls a 4 with this second roll of the dice, which represents $4,000, then the team multiplies the $4,000 by 2, thus equaling an $8,000 sale. This $8,000 sale may be added to the P&L sheet 50. If the team lands on the “Big Sale Die ×1” square 30 with the roll of the dice, and then rolled a 4 with their second roll of the dice, the team would multiply the $4,000 by 1 to equal a $4,000 sale that may be added to the P&L sheet 50.

If roll of the dice lands the team on the corner, i.e., the “Back City Taxes” square 25, the team will owe back taxes of $5,000, which must be paid. Upon moving their token completely around the board 20 (“a round”, i.e, moving token from the Start square 21 all the way around the board back to the Start square 21), each team may add $50,000 to their line of credit (place in “LOC Balance” column 52). The team will go around the board 4 times (i.e., 4 rounds) to complete the game.

If played with multiple teams, upon finishing the game, each team, after paying off line of credit, should total their remaining amount of money (cash on hand). The teams may share with each other their total amount of money remaining after paying off their line of credit. The team with the most money remaining, wins.

In one exemplary embodiment, a company leader (e.g., an owner, executive, manager, supervisor, or other company representative) may prepare and provide discussion questions to the participating teams and team members to discuss and share with the team members and between the teams, if desired. Exemplary questions and discussion points may include, but not be limited to, asking how the game and its different rewards, risks, decisions, etc., were like and/or similar to the industry and/or business that they all are in, what ideas each of them as a team or individually have to make their department, themselves, and/or the company more profitable and/or successful.

In another exemplary discussion that may be initiated after the game, the company leader (e.g., an owner, executive, manager, supervisor, or other company representative) may go over an actual monthly or annual financial statement and share the cost of at least 15 cost items, but fellow co-workers (team participants) must guess before giving the true numbers. This is an eye opener and very educational to all the employees as to the actual costs of operating a business.

In another exemplary embodiment of the game and method of the present invention, a method of play may comprise the following steps (e.g., exemplary game instructions) as set forth below:

1. Keeping the red and blue decks separate; shuffle mix each deck to begin each round. Give each player or team a marker (such as a coin, etc).

2. Place both decks on the table within easy reach of each player or team.

3. Game can be played with up to four players per board or up to six on any one team per board. Any player or team may begin and then play continues in turns.

4. The first player or team begins by rolling the dice and moving their marker.

5. You then pick up a red or blue card depending on the color of the square landed on and proceed to make a decision following the directions on the card.

6. If a player or team runs out of cash, they must draw from their line of credit (L.O.C.) in increments of $10,000. Players are given $50,000 L.O.C. at the beginning of the game and an additional $25,000 per round. Enter the transaction on the score sheet after each play.

7. If a player or team makes a sale or spends cash, they enter the amount on their cash sheet adding or subtracting to their total cash on hand.

8. Players or teams may pay back the L.O.C. at any time.

9. The round is equivalent to a “week” and ends when each player or team returns to or passes the start square. If their final roll of the dice carries them past the start square, they do not have to complete the final card.

10. After paying the L.O.C (if possible) back, the round is won by the player or team with the most cash on hand.

11. After each round, discuss thoroughly each player or teams actions and strategies. Take your time to allow players to reflect on their “week.”
“How did you do?’
“What were the good decisions you made?’
“Did you make any errors?’
“What would you do differently if you had it to do it over again?’
“How is this like your or our business?”

12. Continue all four rounds. The ultimate winner is the one player or team with the most cash on hand when totaling all four rounds.

Having described the invention in detail, those skilled in the art will appreciate that, given the present disclosure; modifications may be made to the invention without departing from the spirit of the inventive concept herein described. Therefore, it is not intended that the scope of the invention be limited to the specific and preferred embodiments' illustrations as described. Rather, it is intended that the scope of the invention be determined by the appended claims.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A board game teaching apparatus wherein a plurality of individual players or teams, each representing separate individual companies attempt to maximize their net profits comprising
a plurality of playing tokens, each piece representing one player or team during use of the board game teaching apparatus;
a plurality of first risk cards having a plurality of risks associated with running a business;
a plurality of cause and effect cards having a plurality of causes associated with running a business and a plurality of effects corresponding to the plurality of causes;
a game board comprising
a playing surface,
a start space,
a first plurality of spaces having a first indicia corresponding to the plurality of risk cards,
a second plurality of spaces having a second indicia corresponding to the plurality of cause and effect cards,
a sale space representing a sale of the company's product, and
an expense space representing an expense of the company; and
a chance indicator having a plurality of numbers, wherein a player or team may activate the chance indicator to identify one of the plurality of numbers.
